(19) United States
(12) Patent Application Publication
(10) Pub. No.: US 2004/0256828 A1
(43) Pub. Date: Dec. 23, 2004

(54) Torsion beam type suspension and forming method for torsion beam

(75) Inventors: Sung-Wook Han, Busan Metropolitan City (KR); Soon-Hyun Park, Ulsan Metropolitan City (KR); Jong-Rae Lee, Ulsan Metropolitan City (KR); Keun-Jae Park, Busan Metropolitan City (KR)

Correspondence Address: William R. McClellan, Wolf, Greenfield & Sacks, P.C., 600 Atlantic Avenue, Boston, MA, 02210, US

(73) Assignee: Donghee Industrial Co., Ltd., Ulsan Metropolitan City (KR)

(21) Appl. No.: 10/748,607

(22) Filed: Dec. 30, 2003

(30) Foreign Application Priority Data
Jun. 18, 2003 (KR) 10-2003-0039464

(51) Int. Cl. B60G 21/05

(52) U.S. Cl. 280/124.106

(57) ABSTRACT

Disclosed herein are a torsion beam type suspension and a forming method of a torsion beam. In the torsion beam type suspension comprising a pair of left and right trailing arms connected to each other through a torsion beam, front ends of the trailing arms being used to mount a vehicle body by using joints, the torsion beam is obtained by forming an overall length of a pipe having a certain wall thickness by using a pressure forming process. In this case, end sections defined at both end portions of the torsion beam have a cross-sectional shape of a hollow oval, a center section defined at a center portion of the torsion beam has a cross-sectional shape of a hollow open loop, and middle sections defined between the center portion and both the end portions of the torsion beam have a cross-sectional shape of a hollow open loop. The loop of the middle sections defines an inner space larger than that defined by the loop of the center section. Further, since the torsion beam can be easily formed by adopting a hydro-forming process, it is possible to achieve high twisting rigidity, bending rigidity, and durability without requiring a torsion bar and reinforcement, which must be inevitably assembled to a conventional torsion beam axle, resulting in a reduction of the number of constitutive elements and the overall weight.

### FIELD OF THE INVENTION

The present invention relates to a torsion beam type suspension and a forming method for a torsion beam.

### BACKGROUND OF THE INVENTION

Suspensions for motor vehicles are devices used to connect a vehicle body and wheels to each other, and are adapted to absorb shock and vibration applied from the road during movement, thereby improving ride comfort and stability of motor vehicles. Such suspensions are basically classified into integral type suspensions wherein left and right wheels are connected by an axle, and independent type suspensions wherein left and right wheels operate individually. The suspensions comprise springs for absorbing shock from the road, shock absorbers adapted to restrict free vibration of the springs, arms or links for controlling the operation of wheels, and the like.

As one example of the above-mentioned independent type suspensions, there is a torsion beam type suspension, which is configured in such a fashion that a pair of left and right trailing arms are coupled to each other by using a single member called a torsion beam or cross beam. Such configuration of the torsion beam type suspension is characterized in that the length of its link is longer, and the number of rubber bushes functioning as oscillating shafts is smaller, compared with strut type or double wishbone type suspensions. The torsion beam type suspension further has several advantages in that it shows low friction hysteresis in relation to a suspension stroke, it can induce a high level of smooth ride comfort, and it can achieve relatively high running stability relative to its low production cost and mass, in spite of the fact that its design performance range is not high due to the simplification of constitutive components thereof. Thus, the torsion beam type suspension has been used as a suspension for use in small and sub-medium sized motor vehicles during the last several decades.

Referring to FIG. 1, which illustrates a conventional torsion beam type suspension, a pair of left and right trailing arms 2 and 2′ are connected by a torsion beam 4, the front ends of the trailing arms 2 and 2′ serve to pivotally support a vehicle body (not shown) by joints 6 and 6′ having rubber bushes, respectively, and the rear ends of the trailing arms 2 and 2′ are coupled with wheels 8 and 8′. Between the trailing arms 2 and 2′ and the vehicle body there are installed suspension springs 10 and 10′, respectively, and to the rear ends of the trailing arms 2 and 2′ there are connected shock absorbers 12 and 12′, respectively.

The conventional torsion beam type suspension constructed as stated above has features in that it causes the deformation of the wheels 8 and 8′ due to the torsional deformation property of the torsion beam 4, and can lead to a toe-in state in case of bumps by virtue of such torsional deformation, position of the trailing arms, and a specific bushing property. The toe-in state means a state wherein, when looking down at the wheels, a front-side distance between wheels aligned on the same axle is shorter than a rear-side distance between the wheels.

In the torsion beam type suspension as stated above, the trailing arms and torsion beam are welded to each other, thereby defining a so-called torsion beam axle. When a pair of left and right wheels move in opposite directions, the torsion beam axle is partially or wholly twisted. Such torsional twisting considerably affects the suspension, and is an important factor for controlling the performance of a motor vehicle, and thus it is positively applied to improve the function of the suspension. For this, the torsion beam should have a high torsional twisting rigidity against the rolling of a motor vehicle, and a high bending rigidity against lateral force inputted through tires in case of turning of a motor vehicle.

The conventional torsion beam, however, is manufactured by forming a thick iron plate having a thickness of about 4 mm to 5 mm to have a cross sectional shape of a rotated letter U (90 degrees to the left), inverted letter V, and inverted letter U, by making use of a press, as shown in FIG. 1. Since the conventional torsion beam has insufficient twisting rigidity, bending rigidity and durability thereof, a separate torsion bar for satisfying a required twisting rigidity or bending rigidity, and a reinforcement for satisfying a required durability should be welded to the torsion beam.

The conventional torsion beam configured as stated above inevitably complicates the overall assembly process due to an increase in the number of constitutive components, and consequently increases the overall weight of a product.

### SUMMARY OF THE INVENTION

The present invention has been made in view of the above problems, and it is an object of the present invention to provide a torsion beam type suspension, which is capable of achieving high twisting rigidity, bending rigidity and durability, without coupling additional components, such as a torsion bar and reinforcement.

It is another object of the present invention to provide a method of easily forming a torsion beam for use in a torsion beam type suspension.

In accordance with one aspect of the present invention, the above and other objects can be accomplished by the provision of a torsion beam type suspension comprising a pair of left and right trailing arms connected to each other through a torsion beam, front ends of the trailing arms being used to mount a vehicle body by using joints, wherein the torsion beam is obtained by forming an overall length of a pipe having a certain wall thickness by using a pressure forming process, wherein the end sections defined at both end portions of the torsion beam have a cross sectional shape of a hollow oval, a center section defined at a center portion of the torsion beam has a cross sectional shape of a hollow open loop, and middle sections defined between the center portion and both the end portions of the torsion beam have a cross sectional shape of a hollow open loop, the loop of the middle sections defining an inner space larger than that of the loop of the center section.

In accordance with another aspect of the present invention, there is provided a forming method of a torsion beam provided in a torsion beam type suspension as set forth in claim 1, comprising the steps of: a) seating a pipe having a circular cross sectional shape and a certain wall thickness on a lower mold, and operating an upper mold and the lower mold, thereby forming the circular pipe to have a cross sectional shape of an oval; b) operating feeding punches located at both ends of the pipe and mounted on a mandrel unit adapted to operate in a longitudinal direction of the pipe, thereby inserting them into both end portions of the pipe; and c) injecting working fluid through center holes formed at the feeding punches, respectively, so as to fill an inner space of the pipe with the working fluid, thereby applying internal pressure to an inner peripheral surface of the pipe, and then operating upper and lower punches, thereby forming outer-side and inner-side portions of the torsion beam.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional torsion beam type suspension;

FIG. 2 is a perspective view illustrating a torsion beam axle of a torsion beam type suspension in accordance with the present invention;

FIG. 3 is a perspective view illustrating a torsion beam shown in FIG. 2;

FIG. 4 is a cross sectional view taken along arrow A-A in FIG. 3;

FIG. 5 is a cross sectional view taken along arrow B-B in FIG. 3;

FIG. 6 is a cross sectional view taken along arrow C-C in FIG. 3;

FIGS. 7a to 7c are sectional views illustrating the sequential steps of forming the torsion beam provided in the torsion beam type suspension in accordance with the present invention;

FIG. 8a is a picture showing the shape of an end portion of the torsion beam when the torsion beam is formed in a state wherein a pipe is subjected to no internal pressure;

FIG. 8b is a picture showing the shape of an end portion of the torsion beam when the torsion beam is formed in a state wherein a pipe is subjected to internal pressure of 5 Mpa; and

FIG. 8c is a picture showing the shape of an end portion of the torsion beam when the torsion beam is formed in a state wherein a pipe is subjected to internal pressure of 10 Mpa.

### DESCRIPTION OF THE PREFERRED EMBODIMENTS

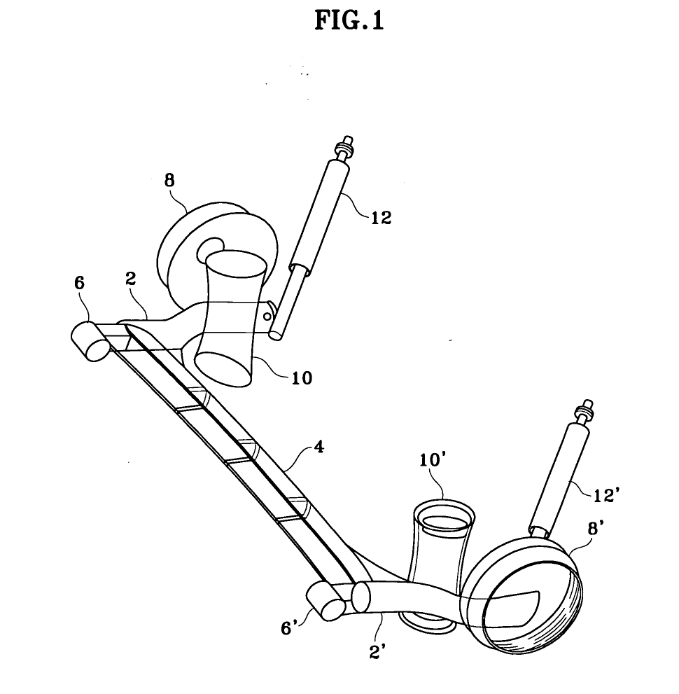

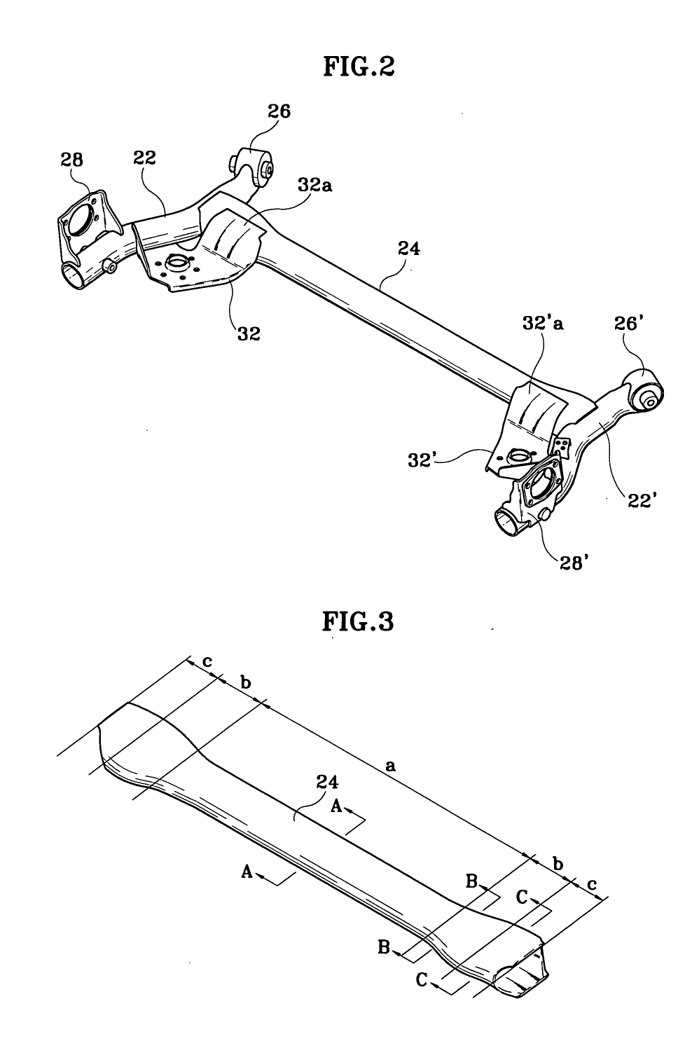

As shown in FIG. 2, a torsion beam type suspension of the present invention is configured in such a fashion that a pair of left and right trailing arms 22 and 22′ thereof are connected to each other through a torsion beam 24. The front ends of the trailing arms 22 and 22′ are adapted to pivotally support a vehicle body (not shown) by using joints 26 and 26′ having rubber bushes, respectively. To the rear ends of the trailing arms 22 and 22′ are welded spindle brackets 28 and 28′ for allowing wheels to be coupled to the rear ends of the tailing arms 22 and 22′, respectively. Further, on the trailing arms 22 and 22′ are welded spring seats 32 and 32′ at portions between the joints 26 and 26′ and spindle brackets 28 and 28′ for the mounting of suspension springs. The configurations of the wheels, suspension springs, shock absorbers, and the like are the same as those shown in FIG. 1.

The trailing arms 22 and 22′ are formed in the shape of a bent pipe.

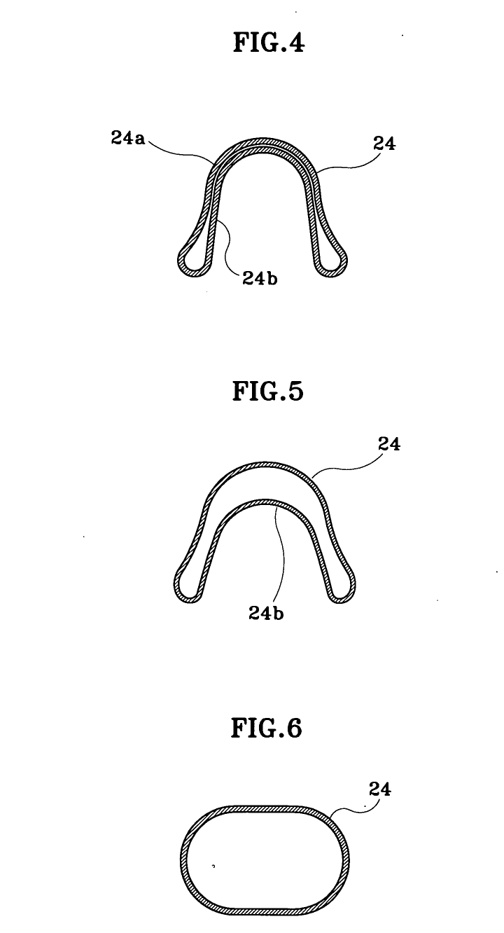

The torsion beam 24 is manufactured by forming the overall length of a pipe having a certain uniform wall thickness by using a pressure forming process. As shown in FIG. 3, the torsion beam 24 is a tubular torsion beam, and can be divided into sections a, b and c. Referring to FIG. 4, which illustrates a cross-sectional shape of the section a positioned at the center portion of the torsion beam 24, the center portion of the torsion beam 24 has a cross-sectional shape of a hollow open loop. Referring to FIG. 6, which illustrates a cross sectional shape of the sections c positioned at both end portions of the torsion beam 24, these end portions have a cross-sectional shape of a hollow oval (or pillow). Referring to FIG. 5, which illustrates a cross-sectional shape of the middle sections b positioned between the section a and sections c, these middle sections b have a cross-sectional shape of a hollow open loop. The loop of the middle sections b defines an inner space larger than that defined by the loop of the section a.

Considering the cross-sectional shape of the open loop shown in FIGS. 4 and 5, the torsion beam 24 has an outer-side portion 24a and an inner-side portion 24b having a certain thickness. The torsion beam may be formed to have various cross-sectional shapes including an inverted letter V, an inverted letter U, and the like. Such cross-sectional shapes provide the torsion beam with large geometrical moment of inertia and polar moment of inertia, thereby allowing the torsion beam to have a high bending rigidity and twisting rigidity.

The torsion beam 24 is processed to have a recessed shape at its end portions so that the end portions come into close contact with the outer peripheral surfaces of the trailing arms 22 and 22′, and are welded thereto.

The spring seats 32 and 32′ are welded at one of their end portions 32a and 32′a to the outer peripheral surface of the torsion beam 24 over the sections b and c (shown in FIG. 3), and at the other end portions to certain portions of the trailing arms 22 and 22′ near the spindle brackets 28 and 28′.

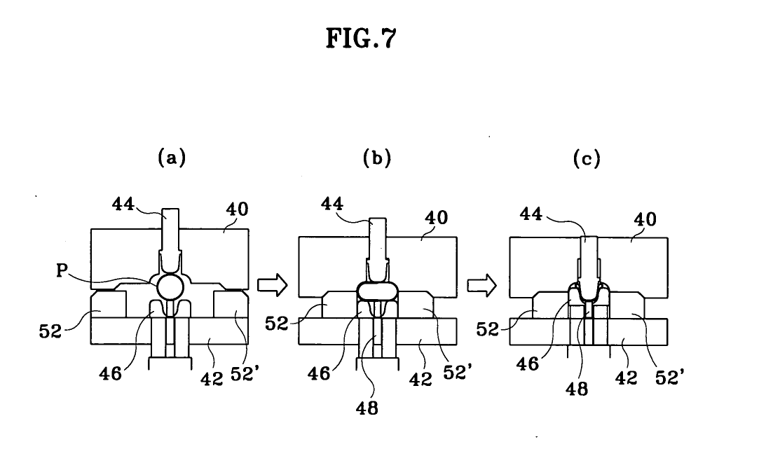

The tubular torsion beam 24 is made of a material, which has a high fatigue endurance as well as a strength capable of independently supporting load. This load, conventionally, is supported by a torsion beam, to which a reinforcement and torsion bar are additionally coupled. Therefore, the tubular torsion beam 24 has a high yield strength and tensile strength, and thus it is difficult for it to apply a general forming process. According to the present invention, the tubular torsion beam 24 is manufactured by using a hydro-forming process as shown in FIGS. 7a to 7c.

The hydro-forming process is performed by a press comprising upper and lower molds 40 and 42 for forming a circular pipe P to have a cross-sectional shape of an oval or pillow, upper and lower punches 44 and 46 for forming the oval or pillow cross-sectional pipe P to have a cross-sectional shape of an inverted letter U-shaped open loop, feeding punches 48 for applying internal pressure to the pipe in a sealed state, and guide molds 52 and 52′ installed at both sides of the lower punch 46.

Next, the sequential steps of forming the tubular torsion beam 24 according to the hydro-forming process will be explained.

First, in a state where the pipe P is seated on the lower mold 42, the upper and lower molds 40 and 42 are operated between the guide molds 52 and 52′ so as to form the circular pipe P to have a cross-sectional shape of an oval. In this way, the forming of the section c shown in FIG. 3 is completed in this step.

Subsequently, the elliptical feeding punches 48, which are located at both ends of the pipe P and mounted on a mandrel unit adapted to operate along a longitudinal direction of the pipe P, are operated so as to be inserted into both the ends of the pipe P. In this inserted state, working fluid is injected through center holes formed at the feeding punches 48 so as to fill the inner space of the pipe, thereby applying internal pressure to the inner peripheral surface of the pipe P. Next, the upper and lower punches 44 and 46 are operated so as to form the outer-side and inner-side portions 24a and 24b of the torsion beam 24. In this step, the forming of the sections b shown in FIG. 3 is performed by adjusting movement distances of the upper and lower punches 44 and 46, and in succession, the forming of the section a shown in FIG. 3 is performed by moving the upper and lower punches 44 and 46.

The working fluid is incompressible fluid, and serves to adjust the internal pressure of the pipe P according to the manipulation of a servo-valve. Since the volume of the inner space of the pipe P is varied as the forming process is advanced, the servo-valve functions to keep the internal pressure of the pipe P at a constant value, thereby preventing the remaining portion of the pipe P from being depressed when the pipe P is formed by the upper and lower punches 44 and 46.

The adjustment of the internal pressure of the pipe P is performed as follows during forming. That is, in a state wherein the pipe is filled with the working fluid, such as water, and maintained at a high pressure of approximately 1500 atm, the internal pressure is gradually removed as the forming progress is advanced, thereby being completely removed at the same time as the completion of the final forming step. Therefore, it is possible to form the pipe to have a desired shape without causing the depression of material and abnormal twisting of the pipe during forming.

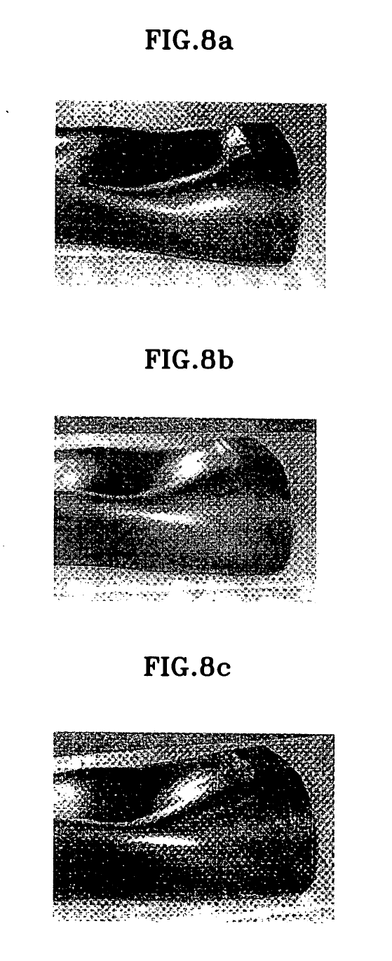

FIG. 8a is a picture showing the shape of an end portion of the torsion beam when the torsion beam is formed in a state wherein a pipe is subjected to no internal pressure. FIG. 8b is a picture showing the shape of an end portion of the torsion beam when the torsion beam is formed in a state wherein a pipe is subjected to internal pressure of 5 Mpa. FIG. 8c is a picture showing the shape of an end portion of the torsion beam when the torsion beam is formed in a state wherein a pipe is subjected to internal pressure of 10 Mpa.

As can be seen from the picture of FIG. 8, when internal pressure is lacking in the pipe, the end portions of the formed torsion beam are steeply depressed. Further, it can be understood that, as shown in FIGS. 8b and 8c, when the torsion beam is formed in a state wherein a certain internal pressure is applied to the pipe, the end portions of the torsion beam are formed into smoothly curved concave surfaces. The internal pressure of the pipe is preferably in a range of 5 Mpa to 10 Mpa during forming. Although the internal pressure can exceed 10 Mpa, it is not preferable in view of cost since such a high internal pressure requires a large-scale press.

As apparent from the above description, the present invention provides a torsion beam type suspension and a forming method for a torsion beam. According to the present invention, since the torsion beam can be formed as a tubular torsion beam having a cross-sectional shape of a hollow open loop or hollow closed oval, the torsion beam can attain a large geometrical moment of inertia and polar moment of inertia, resulting in high bending rigidity and twisting rigidity. Therefore, without requiring a torsion bar and reinforcement, which must be fixed to a conventional torsion beam axle, it is possible to endow the torsion beam type suspension with high twisting rigidity, bending rigidity, and durability. This results in a reduction of the number of constitutive elements and the overall weight. Further, according to the present invention, the torsion beam can be easily formed by adopting a hydro-forming process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A torsion beam type suspension, comprising:
a pair of left and right trailing arms connected to each other through a torsion beam, front ends of the trailing arms being used to mount a vehicle body by using joints, wherein said torsion beam is obtained by forming an overall length of a pipe having a certain wall thickness by using a pressure forming process, and wherein end sections defined at both end portions of said torsion beam have a cross-sectional shape of a hollow oval, a center section defined at a center portion of said torsion beam has a cross-sectional shape of a hollow open loop, and middle sections defined between the center portion and both the end portions of said torsion beam have a cross-sectional shape of a hollow open loop, the loop of the middle sections defining an inner space larger than that defined by the loop of the center section.

2. A forming method of a torsion beam provided in a torsion beam type suspension as defined in claim 1, comprising the steps of:
seating a pipe having a circular cross-sectional shape and a certain wall thickness on a lower mold, and operating an upper mold and the lower mold, thereby forming the circular pipe to have a cross-sectional shape of an oval;
operating feeding punches located at both ends of said pipe and mounted on a mandrel unit adapted to operate in a longitudinal direction of said pipe, thereby inserting them into both end portions of said pipe; and
injecting working fluid through center holes formed at said feeding punches, respectively, so as to fill an inner space of said pipe with said working fluid, thereby applying internal pressure to an inner peripheral surface of said pipe, and then operating upper and lower punches, thereby forming outer-side and inner-side portions of said torsion beam.
